(19) United States
(12) Patent Application Publication
(10) Pub. No.: US 2026/0208332 A1
(43) Pub. Date: Jul. 23, 2026

(54) A SNAP MECHANISM FOR A MECHANICAL TORQUE WRENCH

(71) Applicant: Apex Brands, Inc., Apex, NC (US)

(72) Inventors: Cheng Yang, Shanghai (CN); Gui He, Shanghai (CN); Xiaohui Qin, Shanghai (CN); Ligang He, Shanghai (CN)

(21) Appl. No.: 19/134,969

(22) PCT Filed: Dec. 2, 2022
(86) PCT No.: PCT/CN2022/136078

§ 371 Date: Jun. 2, 2025

(51) Int. Cl. B25B 23/142

(52) U.S. Cl. CPC B25B 23/1427

(57) ABSTRACT

A torque wrench is provided that includes a wrench body, wrench head, slide rod and toggle link. The wrench head includes a workpiece engaging end and an arm that extends from the workpiece engaging end, and the wrench head is pivotably connected to the wrench body such that the arm extends inwardly into the wrench body. The slide rod is disposed within the wrench body, arranged in parallel with the arm, and configured to move axially within the wrench body. The slide rod includes a roller located proximate a first end of the slide rod, and the roller is in sliding contact with an interior surface of the wrench body. The toggle link is pivotably connected to the arm and the slide rod, with the toggle link pivotably connected to the slide rod at a greater distance from the first end of the slide rod than the roller.

### TECHNOLOGICAL FIELD

The present disclosure relates generally to mechanical torque wrenches and, in particular, to a snap mechanism of a clicker type torque wrench.

### BACKGROUND

Fasteners are often used to assemble performance critical components are tightened to a specified torque level to introduce a “pretension” in the fastener. As torque is applied to the head of the fastener, the fastener may begin to stretch beyond a certain level of applied torque. This stretch results in the pretension in the fastener which then holds the components together. Additionally, it is often necessary to further rotate the fastener through a specified angle after the desired torque level has been applied. A popular method of tightening these fasteners is to use a torque wrench.

Torque wrenches may be of mechanical or electronic type. Mechanical torque wrenches are generally less expensive than electronic. There are two common types of mechanical torque wrenches, beam and clicker types. In a beam type torque wrench, a beam bends relative to a non-deflecting beam in response to applied torque. The amount of deflection of the bending beam relative to the non-deflecting beam indicates the amount of torque applied to the fastener. Clicker type torque wrenches have a selectable preloaded snap mechanism with a spring to release at a specified, target torque, thereby generating a click noise to alert the operator to release force on the wrench from which the applied torque is produced.

Although mechanical torque wrenches, and in particular clicker type torque wrenches, provide a number of useful features, it is generally desirable to improve on existing designs.

### BRIEF SUMMARY

Example implementations of the present disclosure are directed to a clicker type torque wrench with an improved snap mechanism. The present disclosure includes, without limitation, the following example implementations.

Some example implementations provide a torque wrench comprising: a wrench body; a wrench head including a workpiece engaging end and an arm that extends from the workpiece engaging end, the wrench head pivotably connected to the wrench body such that the arm extends inwardly into the wrench body; a slide rod disposed within the wrench body, arranged in parallel with the arm, and configured to move axially within the wrench body, the slide rod including a roller located proximate a first end of the slide rod, the roller in sliding contact with an interior surface of the wrench body; and a toggle link pivotably connected to the arm and the slide rod, the toggle link pivotably connected to the slide rod at a greater distance from the first end of the slide rod than the roller.

Some example implementations provide a torque wrench comprising: a wrench body; a wrench head including a workpiece engaging end and an arm that extends from the workpiece engaging end, the wrench head pivotably connected to the wrench body such that the arm extends inwardly into the wrench body; a slide rod disposed within the wrench body, arranged in parallel with the arm, and configured to move axially within the wrench body, the slide rod including a roller located proximate a first end of the slide rod, the roller in sliding contact with an interior surface of the wrench body; and a toggle link pivotably connected to the arm and the slide rod, the toggle link having a planar, curved body that includes a pair of arms joined at an elbow.

Some example implementations provide a torque wrench comprising: a wrench body; a wrench head including a workpiece engaging end and an arm that extends from the workpiece engaging end, the wrench head pivotably connected to the wrench body such that the arm extends inwardly into the wrench body; a slide rod disposed within the wrench body, arranged in parallel with the arm, and configured to move axially within the wrench body, the slide rod including a roller located proximate a first end of the slide rod, the roller in sliding contact with an interior surface of the wrench body, the roller having a contact surface that is in sliding contact with the interior surface of the wrench body, the contact surface having a convex transverse curvature; and a toggle link pivotably connected to the arm and the slide rod.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIG. 1A and 1B illustrate a torque wrench, according to some example implementations of the present disclosure;

FIG. 2 is a cross section of the torque wrench, according to some example implementations;

FIG. 3 is a top view of a portion of the cross section with a focus on components of a snap mechanism of the torque wrench, according to some example implementations; and

FIG. 4 illustrates a front view of a roller of the snap mechanism, according to some example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,” “information,” and similar terms may be at times used interchangeably.

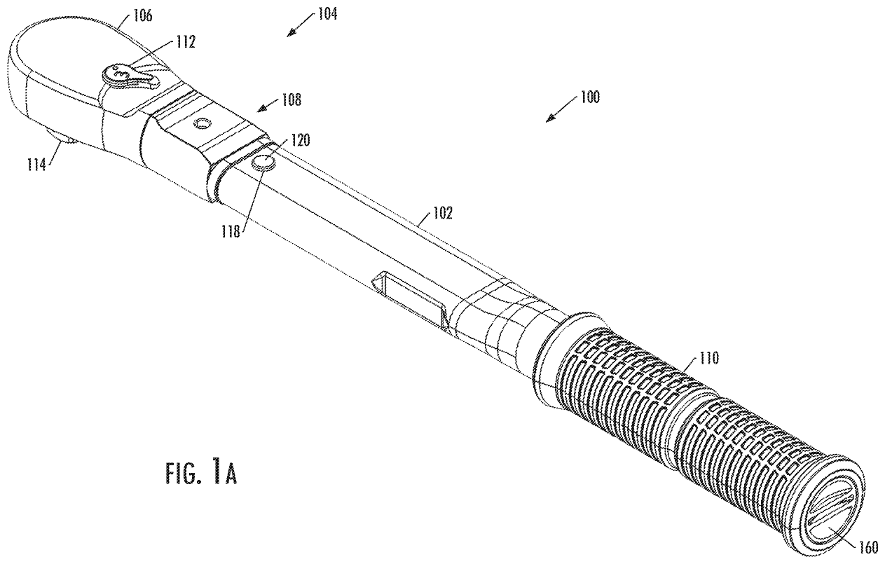

Example implementations of the present disclosure relate generally to mechanical torque wrenches and, in particular, to a snap mechanism of a clicker type torque wrench. FIGS. 1A and 1B illustrate a torque wrench 100, according to some example implementations of the present disclosure.

As shown, the torque wrench 100 includes an elongated wrench body 102, a wrench head 104 including a workpiece engaging end 106 and an arm 108 extending therefrom, and a hand grip 110 attached to one end of wrench body. In various examples, the workpiece engaging end may be formed integral with the arm, or as shown, the workpiece engaging end may be connected to the arm. The workpiece engaging end may include a coupler with a lever 112 that allows a user to select whether torque is applied to a fastener in either a clockwise (CW) or counter-clockwise (CCW) direction. The workpiece engaging end may also include a boss or square drive 114 for receiving variously sized sockets, extensions, etc., which may in turn engage a bolt, nut or other workpiece.

The wrench head 104 may be pivotally connected to a first end of wrench body 102 such that the arm 108 extends inwardly into an interior compartment 116 of the wrench body, and the workpiece engaging end 106 protrudes outwardly from the wrench body. The wrench head may be connected to the wrench body at a pivot joint 118 that includes a pivot pin 120 that is both perpendicular to a longitudinal center axis of the wrench body, and transverse to a plane defined by the torque wrench 100 as it is rotated during torquing operations.

The interior compartment 116 of wrench body 102 may also house a snap mechanism 122 that includes a set spring 124, a slide rod 126 with a roller 128, a spring seat 130 that interconnects the set spring and the slide rod, and a toggle link 132 that interconnects the arm 108 and the slide rod. As shown, in some examples, a first end 134 of the slide rod faces a second end 136 of the arm of the wrench head, and the first end and the second end include respective grooves 138A, 138B in which the toggle link is fit in a tongue-in-groove arrangement. The toggle link may be pivotably connected to the arm by and the slide rod by pins 140 that extend through aligned apertures 142A, 142B, 142C in the toggle link and respective ones of the arm and the slide rod. Similarly, the roller may be connected to the slide rod by a pin that extends through an aligned aperture 144 in the roller, and a notch 146 in the slide rod.

An adjustment assembly 148 is disposed opposite the wrench head 104 for selectively adjusting compression of the set spring 124. The adjustment assembly includes a nut 150, a screw 152, a first stop pin 154, an end block 156, a second stop pin 158, and an end cover 160. The right end of the set spring is seated on the left end of the nut, which is threadably engaged with the screw. The nut is configured to slide within interior compartment 116 of the wrench body 102, with the first stop pin preventing the nut from rotating within the interior compartment. The screw is configured to rotate using a tool such as a screwdriver, which causes the nut to slide left or right and thereby compress or decompress the set spring. A left end of the end block may contact the screw and prevent movement of the screw too far to the right. The end block is fixed within the interior compartment of the wrench body by the second stop pin. The end cover operates as a protective cover.

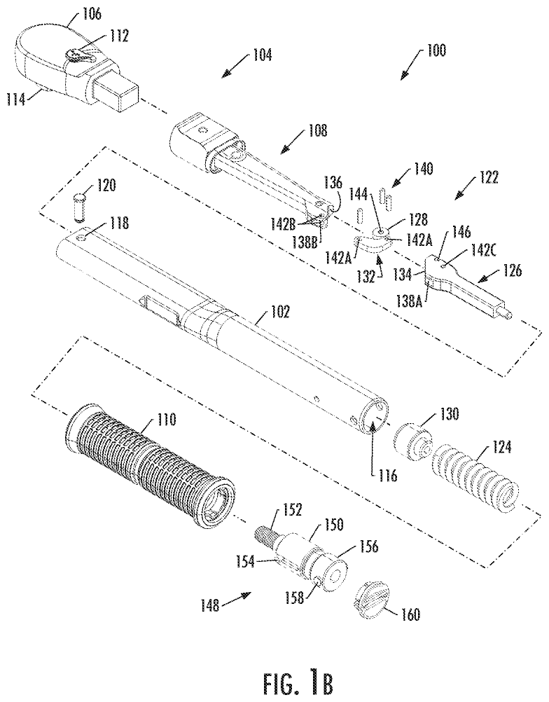

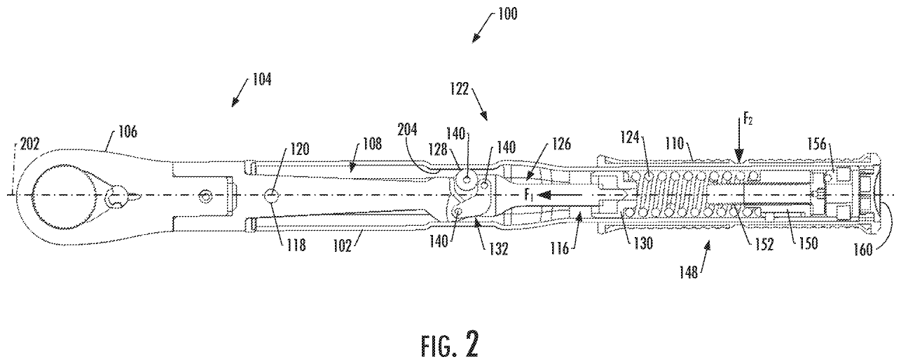

To further describe the snap mechanism 122 of the torque wrench 100, reference is now made to FIGS. 2 and 3. FIG. 2 is a cross section of the torque wrench 100, according to some example implementations. FIG. 3 is a top view of a portion of the cross section with a focus on components of the snap mechanism, according to some example implementations.

As shown, in some examples, the slide rod 126 may be arranged in parallel with the arm 108, and configured to move axially within the wrench body 102, along a longitudinal center axis 202 of the wrench body. The roller 128 may be located proximate the first end 134 of the slide rod, and in sliding contact with an interior surface 204 of the wrench body. In this regard, the set spring 124 may be configured to urge the slide rod 126 toward the wrench head 104 with a force F₁ that causes the roller to contact the interior surface of the wrench body.

When a force F₂ is applied to the wrench body 102 at hand grip 110, a torque may be applied to a bolt, nut or other workpiece engaged with the workpiece engaging end 106 of the wrench head 104. When the force increases, the torque likewise increases; and when the torque reaches a limit sufficient to overcome force F₁, the workpiece engaging end is swung counterclockwise relative to the wrench body. In turn, the toggle link 132 may be engaged to urge the slide rod 126 backward from the wrench head, against force F₁, thereby indicating that the applied torque has reached a value set by force F₁.

As shown in FIGS. 2 and 3, the toggle link 132 may be pivotably connected to the arm 108 and the slide rod 126; and in some examples, the toggle link may be pivotably connected to the slide rod at a greater distance from the first end 134 of the slide rod than the roller 128. In this regard, as shown in FIG. 3, the toggle link may be pivotably connected to the arm at a point A, and to the slide rod at a point B; and the roller may be connected to the slide rod at a point C. The distance d₁ from point B to the first end may greater than the distance d₂ from point C to the first end.

Relative to some other snap mechanism designs, the point B at which the toggle link 132 is connected to the slide rod 126 is moved farther from the first end 134 of the slide rod, with the roller 128 then positioned between the first end and the point B. This may in turn reduce contact stress between the roller and the interior surface 204 of the wrench body 102, and thereby increase the useful life of the torque wrench 100. Moving the point B may also increase the matching distance d₁, which may reduce an additional moment on matching surfaces of the toggle link and slide rod. And reducing this additional moment may further increase the useful life and precision of the torque wrench.

The point B may in some examples be enabled by the shape of the toggle link 132. In this regard, as shown, the toggle link may have a planar, curved (e.g., V-shaped) body 302 that includes a pair of arms 304A, 304B joined at an elbow 306. In some of these examples, the elbow has an inner curved edge 308 that faces the roller 128, and an opposite, outer curved edge 310 that defines an apex of the planar, curved body. Even further, in some examples, the pair of arms may include a first arm 304A and a second arm 304B, and the first arm that is pivotably connected to the arm 108 may be longer than the second arm pivotably connected to the slide rod 126.

In the implementation shown in FIGS. 2 and 3, given the inner curved edge 308, the curved body 302 of the toggle link 132 is asymmetric to a line segment from point A to point B—a line segment A̅B̅. This may allow use of a roller 128 that is larger in size relative to other snap mechanism designs. The radius of the roller may therefore be larger, and the contact stress lower, which may improve the useful life and precision of the torque wrench 100.

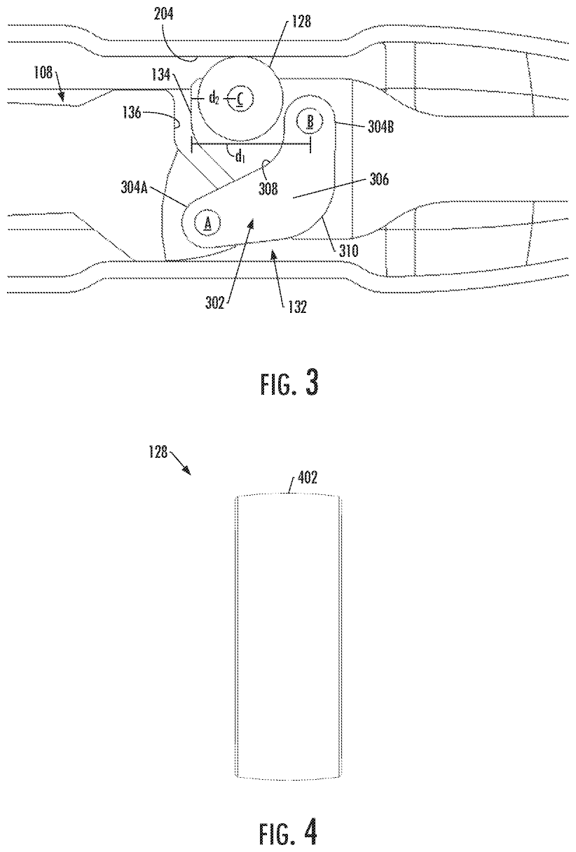

FIG. 4 illustrates a front view of the roller 128 of the snap mechanism 122, according to some example implementations. The roller has a contact surface 402 that is in sliding contact with the interior surface 204 of the wrench body 102; and in some examples, the contact surface has a convex transverse curvature. This may achieve a better match between the contact surface and the interior surface when the interior surface is curved, which may result in manufacturing the wrench body within acceptable engineering tolerances.

As explained above and reiterated below, the present disclosure includes, without limitation, the following example implementations.

Clause 1. A torque wrench comprising: a wrench body; a wrench head including a workpiece engaging end and an arm that extends from the workpiece engaging end, the wrench head pivotably connected to the wrench body such that the arm extends inwardly into the wrench body; a slide rod disposed within the wrench body, arranged in parallel with the arm, and configured to move axially within the wrench body, the slide rod including a roller located proximate a first end of the slide rod, the roller in sliding contact with an interior surface of the wrench body; and a toggle link pivotably connected to the arm and the slide rod, the toggle link pivotably connected to the slide rod at a greater distance from the first end of the slide rod than the roller.

Clause 2. The torque wrench of clause 1, wherein the torque wrench further comprises a set spring disposed within the wrench body, configured to urge the slide rod toward the wrench head with a force that causes the roller to contact the interior surface of the wrench body.

Clause 3. The torque wrench of clause 1 or clause 2, wherein the toggle link is pivotably connected to the arm by and the slide rod by pins that extend through aligned apertures in the toggle link and respective ones of the arm and the slide rod.

Clause 4. The torque wrench of any of clauses 1 to 3, wherein the first end of the slide rod faces a second end of the arm of the wrench head, the first end and the second end including respective grooves in which the toggle link is fit in a tongue-in-groove arrangement.

Clause 5. The torque wrench of any of clauses 1 to 4, wherein the toggle link has a planar, curved body that includes a pair of arms joined at an elbow.

Clause 6. The torque wrench of clause 5, wherein the elbow has an inner curved edge that faces the roller, and an opposite, outer curved edge that defines an apex of the planar, curved body.

Clause 7. The torque wrench of any of clauses 1 to 6, wherein the roller of the slide rod has a contact surface that is in sliding contact with the interior surface of the wrench body, and the contact surface has a convex transverse curvature.

Clause 8. A torque wrench comprising: a wrench body; a wrench head including a workpiece engaging end and an arm that extends from the workpiece engaging end, the wrench head pivotably connected to the wrench body such that the arm extends inwardly into the wrench body; a slide rod disposed within the wrench body, arranged in parallel with the arm, and configured to move axially within the wrench body, the slide rod including a roller located proximate a first end of the slide rod, the roller in sliding contact with an interior surface of the wrench body; and a toggle link pivotably connected to the arm and the slide rod, the toggle link having a planar, curved body that includes a pair of arms joined at an elbow.

Clause 9. The torque wrench of clause 8, wherein the torque wrench further comprises a set spring disposed within the wrench body, configured to urge the slide rod toward the wrench head with a force that causes the roller to contact the interior surface of the wrench body.

Clause 10. The torque wrench of clause 8 or clause 9, wherein the toggle link is pivotably connected to the arm by and the slide rod by pins that extend through aligned apertures in the toggle link and respective ones of the arm and the slide rod.

Clause 11. The torque wrench of any of clauses 8 to 10, wherein the first end of the slide rod faces a second end of the arm of the wrench head, the first end and the second end including respective grooves in which the toggle link is fit in a tongue-in-groove arrangement.

Clause 12. The torque wrench of any of clauses 8 to 11, wherein the elbow has an inner curved edge that faces the roller, and an opposite, outer curved edge that defines an apex of the planar, curved body.

Clause 13. A torque wrench comprising: a wrench body; a wrench head including a workpiece engaging end and an arm that extends from the workpiece engaging end, the wrench head pivotably connected to the wrench body such that the arm extends inwardly into the wrench body; a slide rod disposed within the wrench body, arranged in parallel with the arm, and configured to move axially within the wrench body, the slide rod including a roller located proximate a first end of the slide rod, the roller in sliding contact with an interior surface of the wrench body, the roller having a contact surface that is in sliding contact with the interior surface of the wrench body, the contact surface having a convex transverse curvature; and a toggle link pivotably connected to the arm and the slide rod.

Clause 14. The torque wrench of clause 13, wherein the torque wrench further comprises a set spring disposed within the wrench body, configured to urge the slide rod toward the wrench head with a force that causes the roller to contact the interior surface of the wrench body.

Clause 15. The torque wrench of clause 13 or clause 14, wherein the toggle link is pivotably connected to the arm by and the slide rod by pins that extend through aligned apertures in the toggle link and respective ones of the arm and the slide rod.

Clause 16. The torque wrench of any of clauses 13 to 15, wherein the first end of the slide rod faces a second end of the arm of the wrench head, the first end and the second end including respective grooves in which the toggle link is fit in a tongue-in-groove arrangement.

Clause 17. The torque wrench of any of clauses 13 to 16, wherein the toggle link has a planar, curved body that includes a pair of arms joined at an elbow.

Clause 18. The torque wrench of clause 17, wherein the elbow has an inner curved edge that faces the roller, and an opposite, outer curved edge that defines an apex of the planar, curved body.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A torque wrench comprising:
a wrench body;
a wrench head including a workpiece engaging end and an arm that extends from the workpiece engaging end, the wrench head pivotably connected to the wrench body such that the arm extends inwardly into the wrench body;
a slide rod disposed within the wrench body, arranged in parallel with the arm, and configured to move axially within the wrench body, the slide rod including a roller located proximate a first end of the slide rod, the roller in sliding contact with an interior surface of the wrench body; and
a toggle link pivotably connected to the arm and the slide rod, the toggle link pivotably connected to the slide rod at a greater distance from the first end of the slide rod than the roller.

2. The torque wrench of claim 1, wherein the torque wrench further comprises a set spring disposed within the wrench body, configured to urge the slide rod toward the wrench head with a force that causes the roller to contact the interior surface of the wrench body.

3. The torque wrench of claim 1, wherein the toggle link is pivotably connected to the arm by and the slide rod by pins that extend through aligned apertures in the toggle link and respective ones of the arm and the slide rod.

4. The torque wrench of claim 1, wherein the first end of the slide rod faces a second end of the arm of the wrench head, the first end and the second end including respective grooves in which the toggle link is fit in a tongue-in-groove arrangement.

5. The torque wrench of claim 1, wherein the toggle link has a planar, curved body that includes a pair of arms joined at an elbow.

6. The torque wrench of claim 5, wherein the elbow has an inner curved edge that faces the roller, and an opposite, outer curved edge that defines an apex of the planar, curved body.

7. The torque wrench of claim 1, wherein the roller of the slide rod has a contact surface that is in sliding contact with the interior surface of the wrench body, and the contact surface has a convex transverse curvature.

8. A torque wrench comprising:
a wrench body;
a wrench head including a workpiece engaging end and an arm that extends from the workpiece engaging end, the wrench head pivotably connected to the wrench body such that the arm extends inwardly into the wrench body;
a slide rod disposed within the wrench body, arranged in parallel with the arm, and configured to move axially within the wrench body, the slide rod including a roller located proximate a first end of the slide rod, the roller in sliding contact with an interior surface of the wrench body; and
a toggle link pivotably connected to the arm and the slide rod, the toggle link having a planar, curved body that includes a pair of arms joined at an elbow.

9. The torque wrench of claim 8, wherein the torque wrench further comprises a set spring disposed within the wrench body, configured to urge the slide rod toward the wrench head with a force that causes the roller to contact the interior surface of the wrench body.

10. The torque wrench of claim 8, wherein the toggle link is pivotably connected to the arm by and the slide rod by pins that extend through aligned apertures in the toggle link and respective ones of the arm and the slide rod.

11. The torque wrench of claim 8, wherein the first end of the slide rod faces a second end of the arm of the wrench head, the first end and the second end including respective grooves in which the toggle link is fit in a tongue-in-groove arrangement.

12. The torque wrench of claim 8, wherein the elbow has an inner curved edge that faces the roller, and an opposite, outer curved edge that defines an apex of the planar, curved body.

13. A torque wrench comprising:
a wrench body;
a wrench head including a workpiece engaging end and an arm that extends from the workpiece engaging end, the wrench head pivotably connected to the wrench body such that the arm extends inwardly into the wrench body;
a slide rod disposed within the wrench body, arranged in parallel with the arm, and configured to move axially within the wrench body, the slide rod including a roller located proximate a first end of the slide rod, the roller in sliding contact with an interior surface of the wrench body, the roller having a contact surface that is in sliding contact with the interior surface of the wrench body, the contact surface having a convex transverse curvature; and
a toggle link pivotably connected to the arm and the slide rod.

14. The torque wrench of claim 13, wherein the torque wrench further comprises a set spring disposed within the wrench body, configured to urge the slide rod toward the wrench head with a force that causes the roller to contact the interior surface of the wrench body.

15. The torque wrench of claim 13, wherein the toggle link is pivotably connected to the arm by and the slide rod by pins that extend through aligned apertures in the toggle link and respective ones of the arm and the slide rod.

16. The torque wrench of claim 13, wherein the first end of the slide rod faces a second end of the arm of the wrench head, the first end and the second end including respective grooves in which the toggle link is fit in a tongue-in-groove arrangement.

17. The torque wrench of claim 13, wherein the toggle link has a planar, curved body that includes a pair of arms joined at an elbow.

18. The torque wrench of claim 17, wherein the elbow has an inner curved edge that faces the roller, and an opposite, outer curved edge that defines an apex of the planar, curved body.
